(19) United States
(12) Patent Application Publication
(10) Pub. No.: US 2024/0369426 A1
(43) Pub. Date: Nov. 7, 2024

(54) VACUUM CALORIMETER COMPRISING AN OPEN SYSTEM DIFFERENTIAL CALORIMETER

(71) Applicant: Texas Tech University System, Lubbock, TX (US)

(72) Inventors: Moses Trevor Dardik, Lubbock, TX (US); Robert Vance Duncan, Lubbock, TX (US); Shelby Lynn Lacouture, Lubbock, TX (US); Mitchell Dwain Kelley, Lubbock, TX (US); Madison S. Atwood, Lubbock, TX (US); Dennis Franciscus van der Vliet, Lubbock, TX (US)

(21) Appl. No.: 18/685,163

(22) PCT Filed: Aug. 17, 2022
(86) PCT No.: PCT/US2022/040661

§ 371 Date: Feb. 20, 2024

Related U.S. Application Data
(60) Provisional application No. 63/235,664, filed on Aug. 20, 2021.

(51) Int. Cl. G01K 17/04

(52) U.S. Cl. CPC G01K 17/04

(57) ABSTRACT

An open calorimetry system is configured to measure heat flow from, and power out of or into, a working substance. The working substance can interact with the environment, allowing heat and mass to enter and leave. The embodiments are configured to measure power over five orders of magnitude from 100 μW to 50 W in a normal room temperature environment.

### CROSS REFERENCE TO RELATED PATENT APPLICATIONS

This application claims the priority and benefit under 35 U.S.C. § 119 (e) of U.S. Provisional Patent Application Ser. No. 63/235,664 filed Aug. 20, 2021, entitled “VACUUM CALORIMETER OPEN SYSTEM DIFFERENTIAL CALORIMETER.” U.S. Provisional Patent Application Ser. No. 63/235,664 is herein incorporated by reference in its entirety.

### TECHNICAL FIELD

Embodiments are generally related to the field of laboratory instruments. Embodiments are further related to measurement of heat flux. Embodiments are also related to measurement of power. Embodiments are further related to calorimetry apparatuses. Embodiments are further related to methods and apparatuses for open system calorimetry.

### BACKGROUND

Calorimetry refers generally to the measurement of heat transfer within a calorimetric body. Calorimeters are devices used to measure the heat transfer from systems that are contained inside the calorimetric boundary. Calorimetry is an established science dating back hundreds of years. However, calorimeters remain largely crude instruments, incapable of the precise measurements required in many modern applications.

Most calorimetric systems have historically measured the temperature rise of a substance under test in response to a well-controlled flow of heat into an insulated closed system that contains the substance. This essentially means that the calorimeter does not allow the continuous flow of heat, energy, or mass through the calorimeter volume during the measurement, which constitutes an open system. Closed calorimeter systems are scientifically useful for the static measurement of the heat capacity, or thermal properties of the substance within the closed system, such as the heat liberated during a chemical reaction that is contained within the closed system. Such closed systems are often referred to as “bomb” type calorimeters, and are commercially available. These “bomb” type calorimeters use a constant-volume chamber that are typically used to measure heat generated from a chemical reaction. These calorimeters can provide very accurate measurements of enthalpies of chemical reactions, but they suffer from a number of draw backs since they cannot measure the change in dissipation in complex, dynamical (open) systems.

For example, in cases where changes in power and heat liberation need to be measured, and the system is intrinsically open, meaning heat, power, (or more generally mass) may enter or leave the system continuously during the measurements, or the experiment requires large, and/or odd shaped samples to be measured, current systems are unfit. As a result, bomb calorimeters are not practical for many applications. In addition, bomb calorimeters require complex and custom built equipment that can be very expensive. Acquiring a bomb calorimeter is cost prohibitive for many laboratories where heat measurements may be an integral component of their research.

Thus, while there are several types of calorimeters available commercially, current solutions are generally designed to measure heat flux, power, or thermal properties of a substance from a closed system, i.e., systems where there is no continuous exchange of heat flux, power, or mass with the environment outside of the calorimeter

Accordingly, there is a need for systems and methods that can be used to provide open system calorimetric measurements, that are both accurate and cost effective. Such systems, methods, and apparatuses are disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide laboratory equipment.

It is another aspect of the disclosed embodiments to provide systems and apparatuses for calorimetry.

It is another aspect of the disclosed embodiments to provide methods and systems for measuring heat liberation and heat flow.

It is another aspect of the disclosed embodiments to provide methods, systems, and apparatuses for measuring energy and/or power using calorimeters.

It is another aspect of the disclosed embodiments to provide an open system vacuum calorimeter that operates in an open environment to measure endothermic or exothermic events in a system subjected to a steady heat flux through the system.

For example, in certain aspects, the disclosed embodiments allow measurement of the change in the rate of heat production (Q) from a substance that can continuously exchange mass or heat with the environment. In the disclosed embodiments, the system is configured to hold the substance in a container that allows mass or heat/power to enter and leave, e.g., an experiment/application where electrical power enters the substance, with the goal being to measure the total heat output, including that heat evolved by the substance. The embodiments utilize a closed water loop system where the water temperature is controlled by two solid-state thermoelectric units that act as an electronically controlled ‘heat reservoir’. The water loop enters a sealed ultra-high vacuum chamber, in which the calorimetric and experimental apparatuses are operated. A series of active Peltiers work to control the temperature of the vacuum calorimetric apparatus, while the circulating water works to remove heat generated by the experiment/application. In certain embodiments, an alternate forced thermal extraction system which eliminates the water-cooling loop can be used. In this design, the heat is lifted via conduction along copper rod/s mounted to a copper disc, which is then fitted to a modified CF flange. The bottom of the copper rod/s are affixed to a rectangular copper plate that is attached to the isotherm block.

The embodiments utilize differential calorimetry to cancel external environmental temperature fluctuations via common mode rejection that influence the system primarily through black body radiation. Heat flux is measured by calibrated passive Peltier sensors. Superinsulation or chemical coatings to reduce emissivity can be used inside the vacuum chamber to mitigate radiation produced from the heating of the active experiment/application; this impacts the voltage signal generated on the dummy passive Peltier.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4 depicts an open calorimeter system, in accordance with the disclosed embodiments;

FIG. 5 depicts an open calorimeter system, in accordance with the disclosed embodiments;

FIG. 6 depicts an open calorimeter system, in accordance with the disclosed embodiments;

FIG. 7 depicts a forced thermal extraction system, in accordance with the disclosed embodiments;

FIG. 8 depicts a forced thermal extraction system, in accordance with the disclosed embodiments; and

FIG. 9 depicts steps associated with a method for measuring energy using an open calorimeter system, in accordance with the disclosed embodiments.

### DETAILED DESCRIPTION

Embodiments and aspects of the disclosed technology are presented herein. The particular embodiments and configurations discussed in the following non-limiting examples can be varied, and are provided to illustrate one or more embodiments, and are not intended to limit the scope thereof.

Reference to the accompanying drawings, in which illustrative embodiments are shown are provided herein. The embodiments disclosed can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

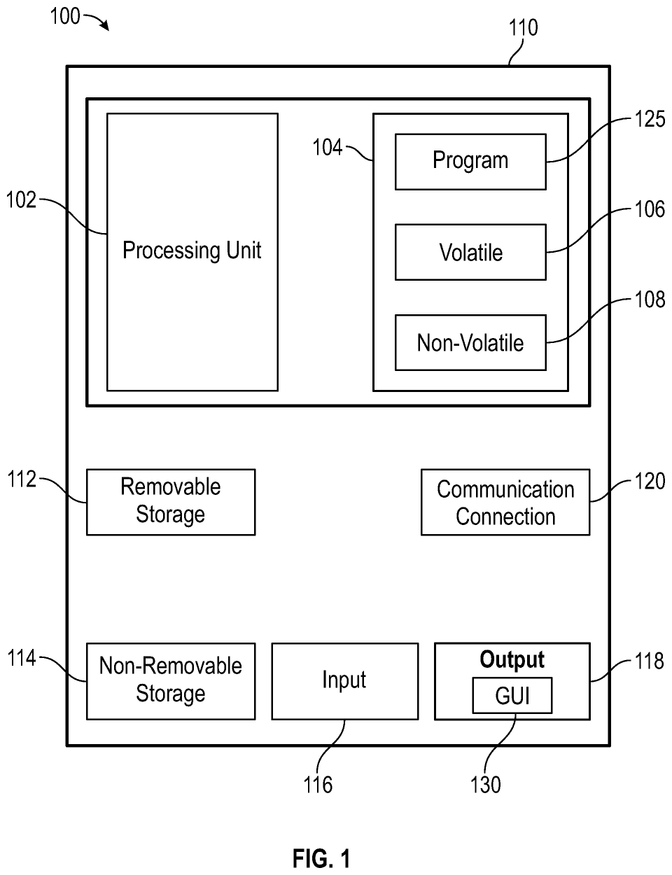

FIGS. 1-3 are provided as exemplary diagrams of data-processing environments in which embodiments may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is provided in FIG. 1. A computing device in the form of a computer 110 configured to interface with controllers, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions, as well as data including image data.

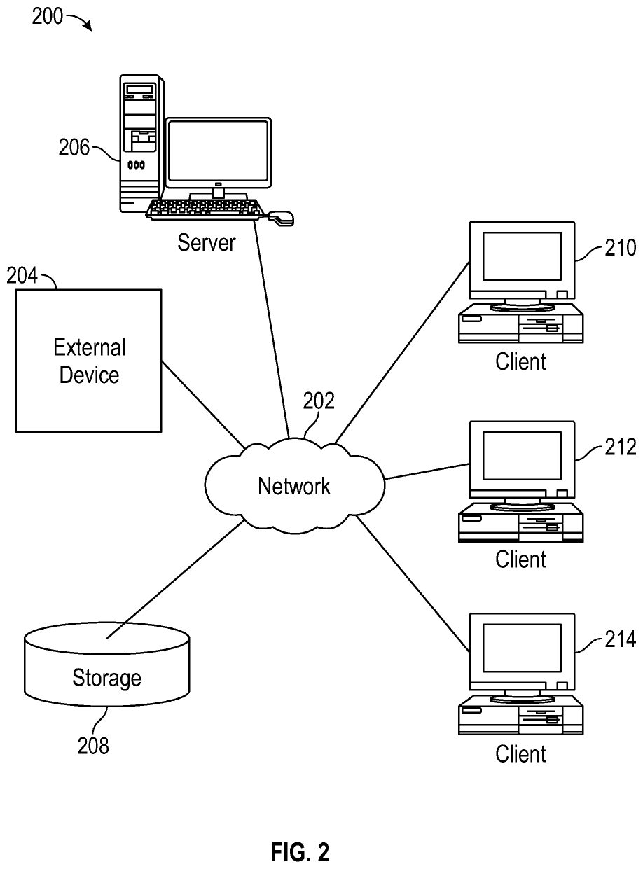

Computer 110 may include, or have access to, a computing environment that includes input 116, output 118, and a communication connection 120. The computer may operate in a networked environment using a communication connection 120 to connect to one or more remote computers, remote sensors and/or controllers, detection devices, hand-held devices, multi-function devices (MFDs), speakers, mobile devices, tablet devices, mobile phones, Smartphone, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to input instructions to computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse, and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 can be a network of computers or other such devices, such as mobile phones, smart phones, sensors, controllers, actuators, speakers, “internet of things” devices, and the like, in which embodiments of the present invention may be implemented. Note that the system 200 can be implemented in the context of a software module such as program module 125. The system 200 includes a network 202 in communication with one or more clients 210, 212, and 214. Network 202 may also be in communication with one or more devices 204, servers 206, and storage 208. Network 202 is a medium that can be used to provide communications links between various devices and computers connected together within a networked data processing system such as computer system 100. Network 202 may include connections such as wired communication links, wireless communication links of various types, and fiber optic cables. Network 202 can communicate with one or more servers 206, one or more external devices such as device 204, and a memory storage unit such as, for example, memory or database 208. It should be understood that device 204 may be embodied as a detector device, controller, receiver, transmitter, transceiver, transducer, driver, signal generator, testing apparatus, or other such device.

In the depicted example, device 204, server 206, and clients 210, 212, and 214 connect to network 202 along with storage unit 208. Clients 210, 212, and 214 may be, for example, personal computers or network computers, handheld devices, mobile devices, tablet devices, smart phones, personal digital assistants, controllers, recording devices, speakers, MFDs, etc. Computer system 100 depicted in FIG. 1 can be, for example, a client such as client 210 and/or 212 and/or 214.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet, with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

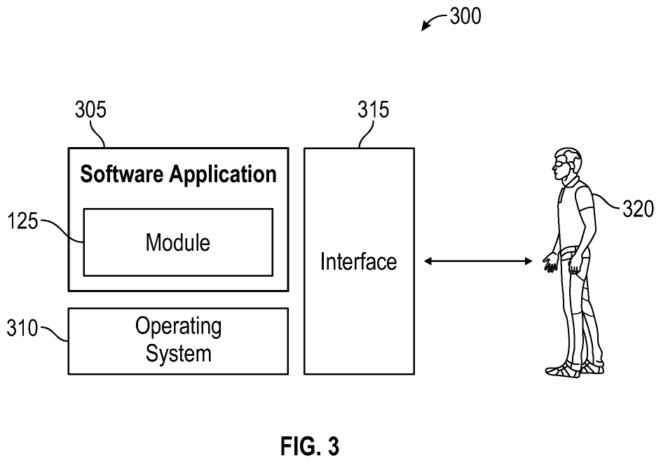

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, and the like.

Note that the term “module” or “node” as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real-time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of, a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the system and method of the present invention may be advantageously applied to a variety of system and application software including database management systems, word processors, and the like. Moreover, the present invention may be embodied on a variety of different platforms including Windows, Macintosh, UNIX, LINUX, Android, Arduino, LabView and the like. Therefore, the descriptions of the exemplary embodiments, which follow, are for purposes of illustration and not considered a limitation.

Aspects of an open system cold plate differential calorimeter, are disclosed in international Application Number PCT/US2021/048763, titled “OPEN SYSTEM COLD PLATE DIFFERENTIAL CALORIMETER” filed Sep. 1, 2021. Although the system disclosed herein is directed to a vacuum calorimeter system, there are aspects of the systems and methods in disclosed international Application Number PCT/US2021/048763, which are equally applicable to the present embodiments. Applicant hereby incorporates by reference International Application Number PCT/US2021/048763, titled “OPEN SYSTEM COLD PLATE DIFFERENTIAL CALORIMETER” in its entirety.

The embodiments disclosed herein are directed to calorimeter devices used to measure heat, energy, and/or power. In an exemplary embodiment, a differential calorimeter can comprise an active vessel and passive vessel. Exemplary active and passive vessels are illustrated in International Application Number PCT/US2021/048763, titled “OPEN SYSTEM COLD PLATE DIFFERENTIAL CALORIMETER.” In the embodiments disclosed herein, each of the active and passive vessels are connected to a heat flux detector via a conductor. A thermal reservoir is connected to the heat flux detectors. The heat flux between the active vessel and the thermal reservoir is measured by one heat flux detector and heat flux between the passive vessel and the thermal reservoir is measured by the other heat flux detector. A differential analysis (common mode rejection) can then be used to compare the heat flux associated with the active vessel to that of the passive vessel. The resulting measurements can then be used to accurately measure the energy or power of the test object in the active vessel.

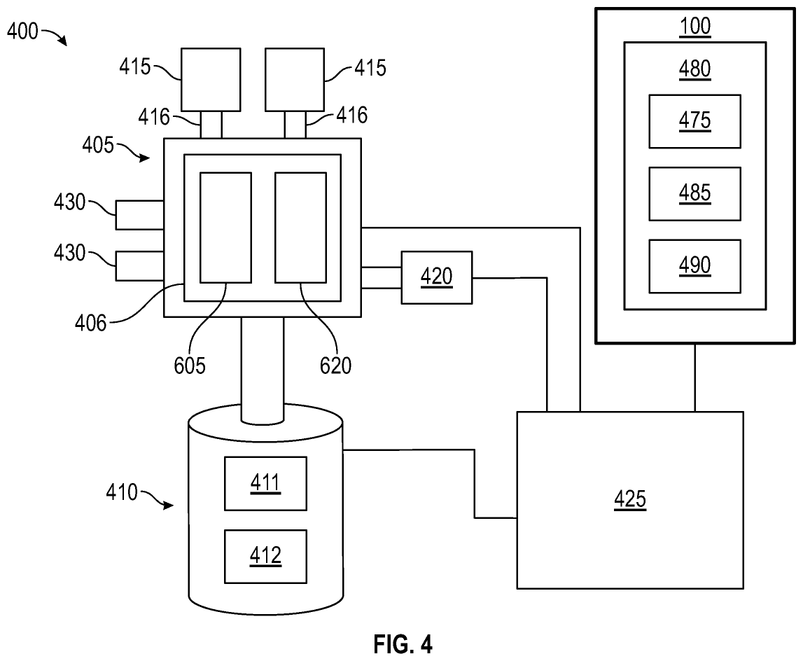

FIG. 4 illustrates a calorimeter system 400 in accordance with the disclosed embodiments. In certain embodiments, the disclosed systems 400 utilize a vacuum chamber pumped to ultra-high vacuum via a pump system to hold the active and passive vessels. In certain embodiments the pump system can comprise a turbo-molecular pump backed by a scroll pump. In certain embodiments, other vacuum drawing systems can be used.

The active and dummy experimental systems as well as the differential calorimeter can be placed inside the vacuum chamber 405. It should be noted that, as used herein, the term “experimental system” can refer to any test piece, test device, or other such substance or apparatus from which measurements are meant to be taken. Each chamber, while conductively isolated from the other by separate heat transfer blocks, can be connected to a metal isotherm block, with a passive measurement Peltier located between each heat transfer block and the isothermal block. Heat generated by the experimental apparatus is removed from the system by a circulating fluid loop. While the fluid can comprise water, in other embodiments, other fluids can also be used.

FIG. 4 illustrates an exemplary illustration of the external components of the system 400. The system 400 generally comprises a vacuum chamber 405 connected to a pumping system 410. As noted, the pump system 410 can comprise a turbomolecular pump 411 backed by a scroll pump 412, or other such vacuum drawing system. This enables ultra-high vacuum to be drawn. In certain embodiments, the ultra-high vacuum can be drawn at up to 10E-8 torr.

Because heat must be removed from this system 400, two thermo-electric coolers 415 can be equipped with welded fluid lines 416 that enter the vacuum system and an external pump that drives fluid flow through the system (forced thermal extraction), or with conductive cooling via conductive rods, as further detailed herein. The internal calorimetric apparatus is externally regulated by proportional-integral-derivative (PID) controllers 420, which regulate the circulated water temperature and voltage on both active Peltiers located inside the vacuum chamber 405. In certain embodiments, a user interface and controller can be provided via computer system 100.

A power supply 425 can regulate the input delivered to the active experiment; however, the system remains open via external manifolds 430. This is critical as it defines the system as an “open calorimeter” in that both energy and/or mass may be placed into or removed from the calorimeter in situ.

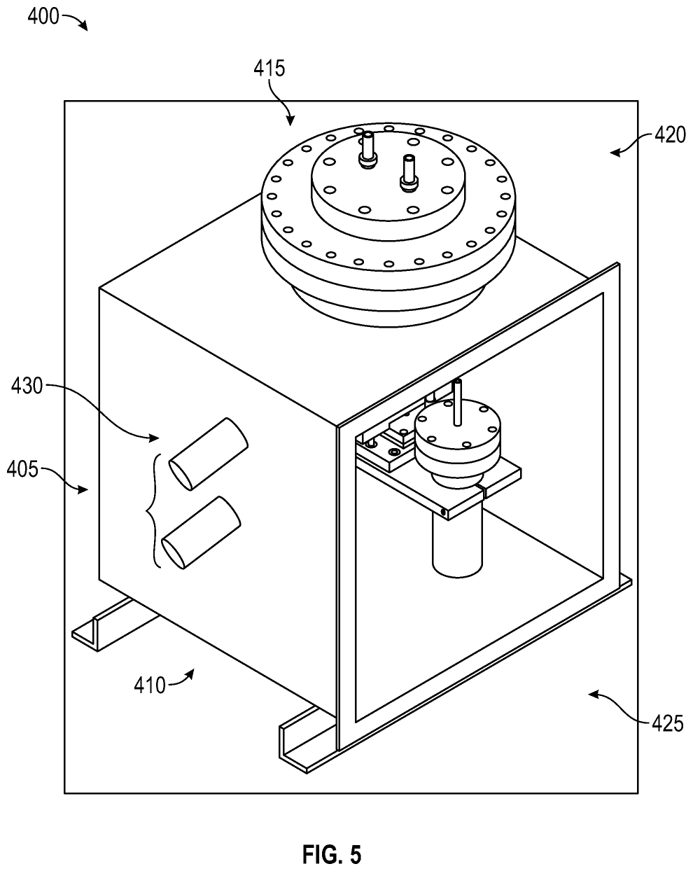

FIG. 5 illustrates aspects of a calorimeter system 400, in accordance with the disclosed embodiments. In this view of the calorimeter 400 the entry door 406 of the vacuum chamber 405 has been removed so that the internal elements are visible.

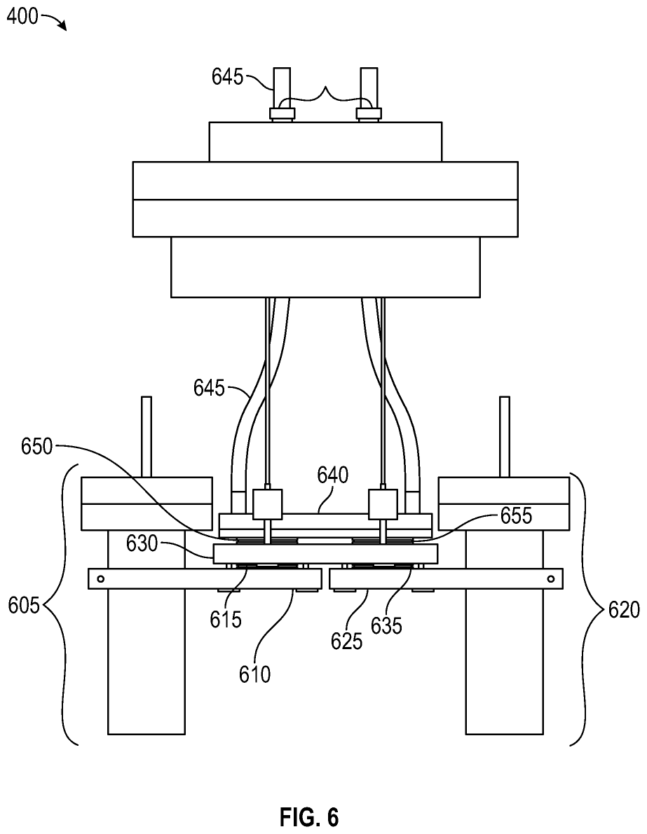

FIG. 6 illustrates the calorimeter system 400 as disclosed herein, with experimental compartments inside of the vacuum chamber 405. As heat is generated via energy input into the active chamber 605, it is conductively transferred along the active heat transfer block 610 to the passive experimental Peltier 615.

Concurrently, the dummy chamber 620 connects to a dummy heat transfer block 625 that is identical to its active counterpart, though the two are physically separated with a single conductive link at the isotherm block 630. The purpose of the dummy portion of the system 400 is to provide common-mode rejection due to unregulated internal heat flux, mostly due to radiative emission as the environment external to the vacuum chamber changes in temperature.

The voltage signals from the first passive Peltier 615 and second passive Peltier 635, are collected and used to calculate the differential signal that forms the function of the calorimeter. The isotherm block 630 is temperature regulated by first active Peltier 650 and the second active Peltier 655 in order to ensure that one side of each passive Peltier is kept thermally stable.

Heat generated from primarily within the experimental chamber must be removed from the system 400. That heat is conducted through the passive Peltiers, isotherm block, and active Peltiers, and lastly transferred to the heat removal block 640. Two water lines 645 can be welded to the heat removal block 640 to transfer the conducted heat out of the calorimeter and vacuum chamber 405 through forced flow up to the thermoelectric coolers. The water in the loop can remain in constant circulation.

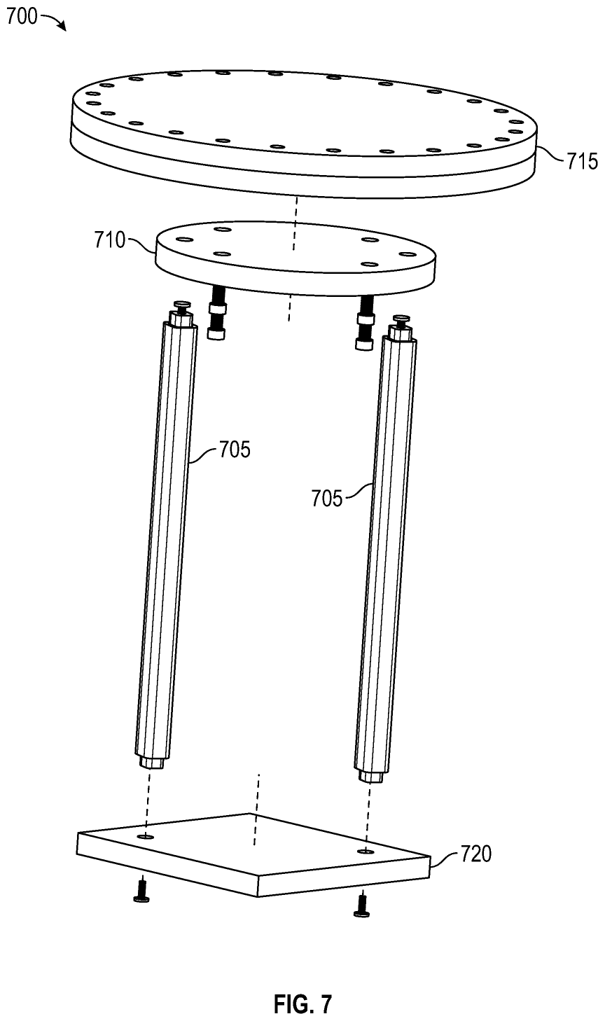

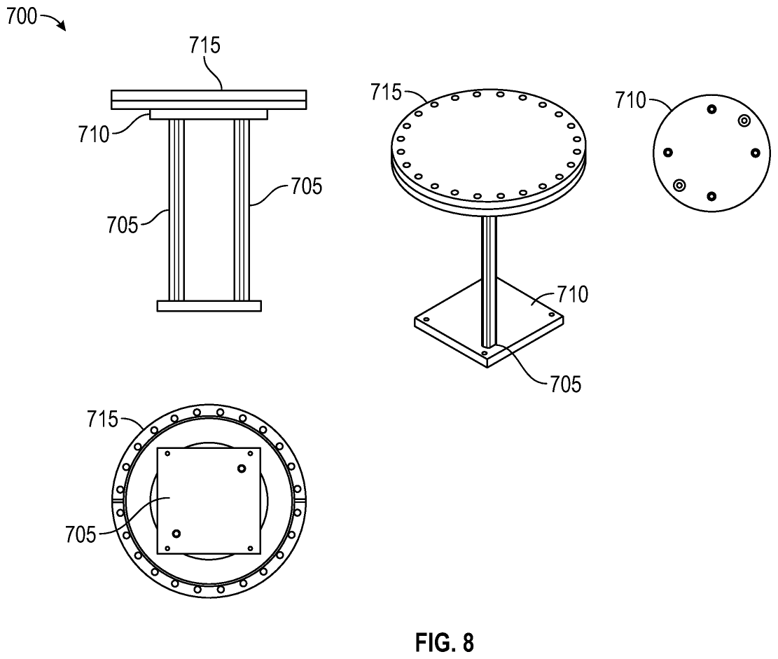

FIGS. 7 and 8 illustrate an alternate forced thermal extraction system 700, which eliminates the water-cooling loop in accordance with the disclosed embodiments. In this embodiment, the heat is lifted via conduction along rods 705 mounted to disc 710. In certain embodiments the rods 705 can comprise copper rods and the disc 710 can comprise a copper disc.

The disc 710 can be fitted to a modified CF flange 715. The bottom of the rods 705 are affixed to a plate 720, which can comprise a rectangular copper plate attached to the isotherm block. An additional design benefit is that the thermo-electric cooler is in direct contact with the modified CF flange 715. Given the proper combination of cooler power and thermal capacitance and resistance of the vacuum chamber, the thermo-electric device will turn the vacuum chamber into its own isotherm. This lends critical reproducibility to calibration of the calorimetric device as this greatly reduces the internal impact of external environmental perturbations, such as changes in room temperature, convective influence, and exposure to radiative sources.

In certain embodiments, the system 400 can use a microcontroller, computer system, or other such device, that measures the asymmetry of each container/sensor/cold-plate path, and calculates a factor to correct for these differences. For example, data from the system can be collected with a computer system as illustrated in FIGS. 1-3. In certain embodiments, the computer system can include a data acquisition module 480. The data acquisition module 480 can include 20-Channel multiplexer card used to capture all signals from the calorimeter. Associated software modules including a calibration module 475, analysis module 485 and output module 490, which can be used to interface with the data acquisition module and display results via a Graphical User Interface (GUI) 130.

In further embodiments the data acquisition can either be external as in the units in use at CEES, which are Agilent multiplexers, or can be designed into the calorimeter itself. The function of this hardware is to record the waveforms from the output of the system. A computer receives the data and processes it. During the calibration process, a symmetry factor and scaling factor are calculated. If calibration coefficients and a symmetry factor have already been acquired, the energy or power calculated can be displayed in real-time.

Explicit calibration and correction factors can be computed with the calibration module 475, to improve the accuracy and precision of the systems disclosed herein. The thermal relationship underpinning the physical phenomenon being measured by can be compactly represented by Fourier's law of heat conduction as presented in equation (1) as follows:

$$Qcond = - kA dT / dx \qquad ( 1 )$$

Where k is the thermal conductivity and A is the area normal to the direction of the heat flow. The heat flow is a constant, making the temperature gradient also constant. This leads to a simple relationship between the heat flow through a piece of material, the temperature difference developed across it, and the physical dimensions of the material.

The thermal conductivity depends on the material and the physical geometry through which heat conduction takes place. A similar thermal relationship exists for both convection and radiation of heat from the surface of a material, for which only the surface area of the material affects the equivalent lumped thermal transfer of a given shape.

Note, in a black body with an internal pressure of 10E-5 torr or lower, convection does not play a critical role in the thermodynamics of the system. Radiation and convection are the dominant forms of flux. However, convection is relevant with respect to the interaction of the vacuum chamber with the external environment. It is therefore necessary to note the engineered isothermal vacuum chamber keeps radiation transfer from the environment through the chamber onto the calorimetric apparatus reproducible. This also greatly reduces external convective influence, thereby lending statistical validity to the disclosed embodiments.

To arrive at the desired corrections for the calorimeter system 400, the calorimeter itself can be broken into segments that are approximately delineated by isotherms where heat flow can be considered one-dimensional. This method is intended to observe system response to altered parameters and external perturbations but better absolute accuracy can be obtained by increasing the number of elements corresponding to each physical segment.

In certain aspects, use of an active cold-plate as a heat reservoir and a stable reference will improve the accuracy of the calorimeter. However, another source of error in such an open system, can result from any asymmetry in the heat conduction path between the active vessel and the passive vessel to ambient temperature. This is especially true when considering thermal transfer via radiation paths. In particular mismatched thermal paths and variations in surface emissivity introduce errors and cause a reduction in the differential common mode rejection (CMR) by altering the systems' symmetry.

In order to reject the common mode signal (ambient temperature in this case) the ratios of each branch's thermal paths must be equal. This is expressed in equation (2) as follows:

$${R}_{sense \_ act} = {R}_{sense \_ pass} {R}_{sense \_ act} + {R}_{loss \_ act} {R}_{sense \_ pass} + {R}_{loss \_ pass} \qquad ( 2 )$$

While it would be a physical impossibility to “trim” the thermal conduction and radiative resistances, and perfectly match each flux sensor's sensitivity, a mathematical correction can be applied to the signal to regain good CMR in post-processing of the data with the calibration module 475. A simple reading of each sensor is taken with no applied input power and the ratio of average Vactive to average Vpassive is obtained. This correction factor is used to mathematically bring the system back into ‘balance’. The form of the corrected measured power signal is then given by equation (3) as:

$$Q = C ( V - λ V ) \qquad ( 3 )$$

Where λ is the dimensionless, empirically acquired correction factor, and C is a scaling factor in units of W/V. The correction factor mathematically restores the ratios of the thermal conductance and radiation paths, and restores the calorimeter's CMR with the use of a simple initial measurement, and a slightly altered Qmeasured calculation done with the calibration module 475. The symmetry factor is very effective. In particular, the symmetry factor can be introduced in the calibration sequence (input power stepping).

While heat conduction is a relatively weak function of temperature, radiation is a strong function of temperature, and the surface emissivity can be difficult to predict and control between active and passive vessels. The local temperature of the heatsink is a function of heat flow, ambient temperature, and spatial position. Thus, in the disclosed embodiments a cold plate can be used. The active cold-plate calorimeter output is unperturbed by fluctuations in ambient temperature.

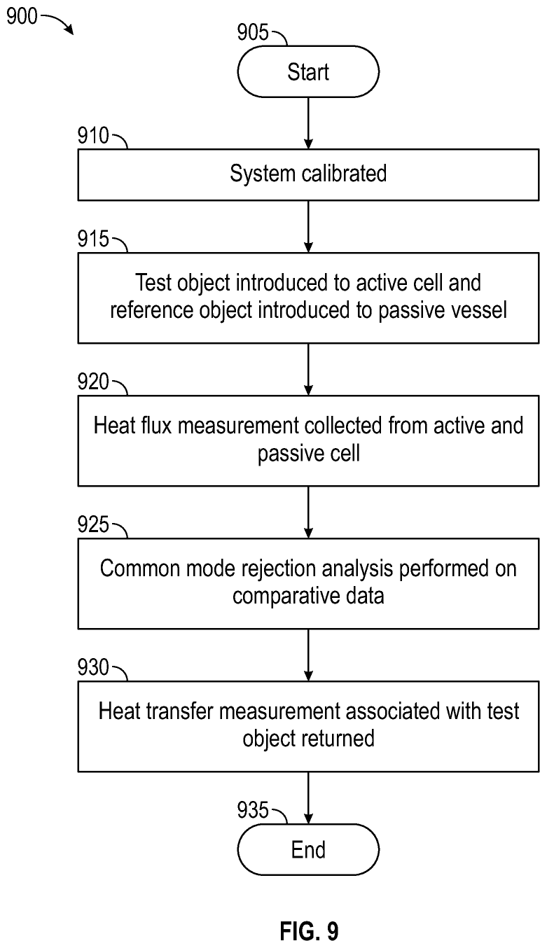

FIG. 9 illustrates steps associated with a method 900 for measuring heat transfer with a calorimeter system as disclosed herein. The method begins at 905.

At step 910 the system 400 can be calibrated with the calibration module. Calibration can generally include determining the correction factor and scaling factor. It should be noted that Calibration steps are arbitrary considering the experiment being calibrated for. The calibration represents the theoretical range that the user will conduct their empirical repertoire.

Next at step 915, the test object and reference object can be added to the active and passive chambers respectively. At step 920, testing can be initiated and heat flux measurements can be collected from the active cell and the passive cell and provided to the data acquisition module.

The acquired data can then be subject to a common mode rejection analysis by common mode rejection module, as shown at step 925. Common mode rejection (the canceling of common heat flux sensor signals produced by environmental temperature variations) is obtained nominally by subtracting the active signal from the passive. With the variations inherent in such a system, the overall sensitivity of each container's sensor for a given energy flow are not matched. The sensor's overall sensitivity can, however, be matched with a mathematical correction factor. This factor is found by measuring the signal from each sensor (with no power generated in either container) and averaging these signals over a finite time period. The averaged active signal is then divided by the averaged passive signal. This factor(S) then multiplies the passive flux sensor signal. A scaling factor (C) then multiplies the expression to obtain power out in units of Watts: Pout=C*(Active−S*Passive).

The resulting heat transfer measurement can then be provided via the output module, as illustrated by step 930. The method ends at 935.

The disclosed technology is unique in that it allows the measurement of energy and power from an ‘open’ system, where a heat flux enters and leaves the calorimetric boundary in a well-controlled manner. In an embodiment, the disclosed systems and methods can be used to measure heat flow from, and power out of or into a working substance. The working substance can interact with the environment, allowing heat and mass to enter and leave. The model incorporating all of the elements described accurately and reliably measure power over five orders of magnitude from 100 μW to 50 W in a normal room temperature environment.

Based on the foregoing, it can be appreciated that a number of embodiments, preferred and alternative, are disclosed herein. In an embodiment, a calorimeter comprises an active chamber, a passive chamber, a first heat flux detector connected to the active chamber, a second heat flux detector connected to the passive chamber, a heat removal block, and a vacuum chamber configured to hold the active chamber and passive chamber.

In an embodiment, the calorimeter comprises a vacuum assembly connected to the vacuum chamber. In an embodiment the vacuum assembly further comprises a turbomolecular pump and a scroll pump backing the turbomolecular pump.

In an embodiment, the calorimeter further comprises at least one thermo-electric cooler. In an embodiment, the calorimeter further comprises two active Peltiers, wherein the Peltiers maintain temperature of an isotherm block. In an embodiment the calorimeter further comprises two passive Peltiers, wherein voltage signals are collected from the passive Peltiers to calculate a differential signal.

In an embodiment, the calorimeter further comprises at least one waterline thermally coupled to the heat removal block.

In another embodiment, a system comprises an active chamber, a passive chamber, two active Peltiers, wherein the Peltiers maintain temperature of an isotherm block, two passive Peltiers, wherein voltage signals are collected from the passive Peltiers; to calculate a differential signal, a vacuum chamber configured to hold the active chamber and passive chamber, and a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured to receive the voltage signals and calculate a differential signal.

In an embodiment, the system further comprises a first heat flux detector connected to the active chamber, a second heat flux detector connected to the passive chamber, and a heat removal block. In an embodiment, the system further comprises a vacuum assembly connected to the vacuum chamber. In an embodiment, the vacuum assembly further comprises: a turbomolecular pump and a scroll pump backing the turbomolecular pump. In an embodiment, the system comprises at least one thermo-electric cooler. In an embodiment, the system further comprises at least one waterline thermally coupled to the heat removal block.

In an embodiment, a method for measuring heat transfer comprises introducing a test object to an active cell in a vacuum chamber, introducing a dummy object to a passive cell in the vacuum chamber, collecting a signal from the active cell and the passive cell, and performing common mode rejection analysis on the signal from the active call and the passive cell.

In an embodiment, the method further comprises calibrating the active cell and the passive cell. In an embodiment, calibrating the active cell and the passive cell further comprises determining a correction factor and determining a scaling factor. In an embodiment, the correction factor is determined by averaging the signal from the active cell and the passive cell. In an embodiment of the method performing common mode rejection analysis on the signal from the active cell and the passive cell further comprises subtracting the signal from the active cell from the signal from the passive cell.

In an embodiment, the method further comprises removing heat from the active cell and the passive cell with a heat removal block. In an embodiment, the method further comprises drawing a vacuum in the vacuum chamber with a vacuum assembly connected to the vacuum chamber.

It will be appreciated that variations of the above-disclosed and other features and functions, or alternatives thereof, may be desirably combined into many other different systems or applications. Also, it should be appreciated that various presently unforeseen or unanticipated alternatives, modifications, variations or improvements therein may be subsequently made by those skilled in the art which are also intended to be encompassed by the following claims.

What is claimed is:

1. A calorimeter comprising:
an active chamber;
a passive chamber;
a first heat flux detector connected to the active chamber;
a second heat flux detector connected to the passive chamber;
a heat removal block; and
a vacuum chamber configured to hold the active chamber and passive chamber.

2. The calorimeter of claim 1 further comprising:
a vacuum assembly connected to the vacuum chamber.

3. The calorimeter of claim 2 wherein the vacuum assembly further comprises:
a turbomolecular pump; and
a scroll pump backing the turbomolecular pump.

4. The calorimeter of claim 1 further comprising:
at least one thermo-electric cooler.

5. The calorimeter of claim 1 further comprising:
two active Peltiers, wherein the active Peltiers maintain temperature of an isotherm block.

6. The calorimeter of claim 5 further comprising:
two passive Peltiers, wherein voltage signals are collected from the passive Peltiers to calculate a differential signal.

7. The calorimeter of claim 1 further comprising:
at least one waterline thermally coupled to the heat removal block.

8. A system comprising:
an active chamber;
a passive chamber;
two active Peltiers, wherein the active Peltiers maintain temperature of an isotherm block;
two passive Peltiers, wherein voltage signals are collected from the passive Peltiers to calculate a differential signal;
a vacuum chamber configured to hold the active chamber and passive chamber; and
a computer system, the computer system further comprising:
at least one processor;
a graphical user interface; and
a computer-usable medium embodying computer program code, the computer-usable medium capable of communicating with the at least one processor, the computer program code comprising instructions executable by the at least one processor and configured to:
receive the voltage signals; and
calculate a differential signal.

9. The system of claim 8 further comprising:
a first heat flux detector connected to the active chamber;
a second heat flux detector connected to the passive chamber; and
a heat removal block.

10. The system of claim 9 further comprising:
a vacuum assembly connected to the vacuum chamber.

11. The system of claim 10 wherein the vacuum assembly further comprises:
a turbomolecular pump; and
a scroll pump backing the turbomolecular pump.

12. The system of claim 8 further comprising:
at least one thermo-electric cooler.

13. The system of claim 8 further comprising:
at least one waterline thermally coupled to a heat removal block.

14. A method for measuring heat transfer comprising:
introducing a test object to an active cell in a vacuum chamber;
introducing a dummy object to a passive cell in the vacuum chamber;
collecting a signal from the active cell and the passive cell;
performing common mode rejection analysis on the signal from the active cell and the passive cell.

15. The method for measuring heat transfer of claim 14 further comprising:
calibrating the active cell and the passive cell.

16. The method for measuring heat transfer of claim 15 wherein calibrating the active cell and the passive cell further comprises:
determining a correction factor; and
determining a scaling factor.

17. The method for measuring heat transfer of claim 16, wherein the correction factor is determined by averaging the signal from the active cell and the passive cell.

18. The method for measuring heat transfer of claim 14 wherein performing common mode rejection analysis on the signal from the active cell and the passive cell further comprises:
subtracting the signal from the active cell from the signal from the passive cell.

19. The method for measuring heat transfer of claim 14 further comprises:
removing heat from the active cell and the passive cell with a heat removal block.

20. The method of claim 14 further comprising:
drawing a vacuum in the vacuum chamber with a vacuum assembly connected to the vacuum chamber.
